(19) United States
(12) Patent Application Publication
(10) Pub. No.: US 2022/0198829 A1
(43) Pub. Date: Jun. 23, 2022

(54) MOBILE COMMUNICATIONS DEVICE AND APPLICATION SERVER

(71) Applicant: Telefonaktiebolaget LM Ericsson (publ), Stockholm (SE)

(72) Inventors: Tommy ARNGREN, Södra Sunderbyn (SE); Peter ÖKVIST, LULEÅ (SE)

(21) Appl. No.: 17/603,737

(22) PCT Filed: Apr. 15, 2019
(86) PCT No.: PCT/EP2019/059691

§ 371 Date: Oct. 14, 2021

(51) Int. Cl. G06V 40/16; G06V 40/18; H04N 7/18

(52) U.S. Cl. CPC G06V 40/172; G06V 40/168; H04N 7/183; G06V 40/161; G06V 40/18

(57) ABSTRACT

A mobile communications device (MCD) including a camera, and an application server (AS) are provided. The MCD is operative to capture an image using the camera, transmit information indicating a time of capturing the image, and information pertaining to a field-of-view of the camera, to the AS, and receive identification information pertaining to one or more persons which are potentially present in the captured image from the AS. The AS is operative to receive information pertaining to positions of persons at respective times, store the received information pertaining to positions of persons at respective times in a database, and receive information indicating a time of capturing an image by a camera included in an MCD, and information pertaining to a field-of-view of the camera, from the MCD.

### TECHNICAL FIELD

The invention relates to a mobile communications device, an application server, a method performed by a mobile communications device, a method performed by an application server, and corresponding computer programs, computer-readable storage media, and data carrier signals.

### BACKGROUND

In recent years, camera-equipped mobile communications devices such as smartphones, Head-Mounted Displays (HMDs), life loggers, smartwatches, and camera glasses, have become ubiquitous. This is accompanied by an increasing popularity of Internet services for sharing images or videos. These services are oftentimes provided by social networks like Facebook, Twitter, YouTube, and the like, which typically use cloud-based platforms. With the more widespread use of first-person camera devices such as camera glasses (e.g., Google Glass), it can be expected that continuous capturing and sharing of image/video content, by upload to cloud-based services via wireless communications networks, will become more prominent and commonly accepted in the always-connected future society.

Many social networks have the ability to tag images with the identity of persons represented in these images, based on face recognition algorithms which are applied to images captured by users for the purpose of sharing these via social networks. Face recognition may either be performed on the mobile communications devices which have captured the images, i.e., before they are uploaded to a social-network platform, or after upload using the social-network infrastructure. Face recognition in such cases can typically only be performed for faces of persons which are known to the user who has captured an image. Frequently, these persons are social-network contacts of the user.

### SUMMARY

It is an object of the invention to provide an improved alternative to the above techniques and prior art.

More specifically, it is an object of the invention to provide an improved solution for recognizing faces which are present in mages captured by mobile communications devices by means of face recognition.

These and other objects of the invention are achieved by means of different aspects of the invention, as defined by the independent claims. Embodiments of the invention are characterized by the dependent claims.

According to a first aspect of the invention, a mobile communications device is provided. The mobile communications device comprises a camera, a positioning sensor, an orientation sensor, a wireless network interface, and a processing circuit. The processing circuit causes the mobile communications device to be operative to capture an image using the camera, transmit information indicating a time of capturing the image, and information pertaining to a field-of-view of the camera during capturing the image, to an application server, and to receive identification information pertaining to one or more persons which are potentially present in the captured image from the application server.

According to a second aspect of the invention, an application server is provided. The application server comprises a network interface, and a processing circuit. The processing circuit causes the application server to be operative to receive information pertaining to positions of persons at respective times, and to store the received information pertaining to positions of persons at respective times in a database. The processing circuit causes the application server to be further operative to receive information indicating a time of capturing an image by a camera comprised in a mobile communications device, and information pertaining to a field-of-view of the camera during capturing the image, from the mobile communications device. The processing circuit causes the application server to be further operative to select one or more persons which are potentially present in the captured image, to acquire identification information pertaining to the one or more selected persons which are potentially present in the captured image, and to transmit at least part of the acquired identification information pertaining to one or more persons which are potentially present in the captured image to the mobile communications device.

According to a third aspect of the invention, a method performed by a mobile communications device is provided. The method comprises capturing an image using a camera comprised in the mobile communications device, transmitting information indicating a time of capturing the image, and information pertaining to a field-of-view of the camera during capturing the image, to an application server, and receiving identification information pertaining to one or more persons which are potentially present in the captured image from the application server.

According to a fourth aspect of the invention, a computer program is provided. The computer program comprises instructions which, when the computer program is executed by a processor comprised in a mobile communications device, cause the mobile communications device to carry out the method according to the third aspect of the invention.

According to a fifth aspect of the invention, a computer-readable storage medium is provided. The computer-readable storage medium has stored thereon the computer program according to the fourth aspect of the invention.

According to a sixth aspect of the invention, a data carrier signal is provided. The data carrier signal carries the computer program according to the fourth aspect of the invention.

According to a seventh aspect of the invention, a method performed by an application server is provided. The method comprises receiving information pertaining to positions of persons at respective times, and storing the received information pertaining to positions of persons at respective times in a database. The method further comprises receiving information indicating a time of capturing an image by a camera comprised in a mobile communications device, and information pertaining to a field-of-view of the camera during capturing the image, from the mobile communications device. The method further comprises selecting one or more persons which are potentially present in the captured image, acquiring identification information pertaining to the one or more selected persons which are potentially present in the captured image, and transmitting at least part of the acquired identification information pertaining to one or more persons which are potentially present in the captured image to the mobile communications device.

The invention makes use of an understanding that face recognition which is performed on images captured by mobile communications devices, such as mobile phones, smartphones, tablets, smartwatches, digital cameras, camera glasses, Augmented Reality/Virtual Reality (AR/VR) headsets, Head-Mounted Displays (HMDs), or life loggers, can be improved by acquiring identification information for persons which are potentially present in the captured images, i.e., persons whose faces may be present in the captured images. This is achieved by selecting such potentially present persons as persons which were positioned within the field-of-view of the camera during capturing the image. The acquired identification information is used by a face-recognition algorithm for recognizing faces which are present in the captured images.

Even though advantages of the invention have in some cases been described with reference to embodiments of the first and second aspects of the invention, corresponding reasoning applies to embodiments of other aspects of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates recognizing faces which are present in images captured by a mobile communications device, with assistance by an application server, in accordance with embodiments of the invention.

FIG. 2 shows a sequence diagram illustrating recognizing faces which are present in an image captured by a mobile communications device, where face recognition is performed the mobile communications device, in accordance with embodiments of the invention.

FIG. 3 shows a sequence diagram illustrating recognizing faces which are present in an image captured by a mobile communications device, where face recognition is performed by an application server, in accordance with other embodiments of the invention.

FIG. 4 shows a mobile communications device, in accordance with embodiments of the invention.

FIG. 5 shows an application server, in accordance with embodiments of the invention.

FIG. 6 shows a flow chart illustrating a method performed by a mobile communications device, in accordance with embodiments of the invention.

FIG. 7 shows a flow chart illustrating a method performed by an application server, in accordance with embodiments of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

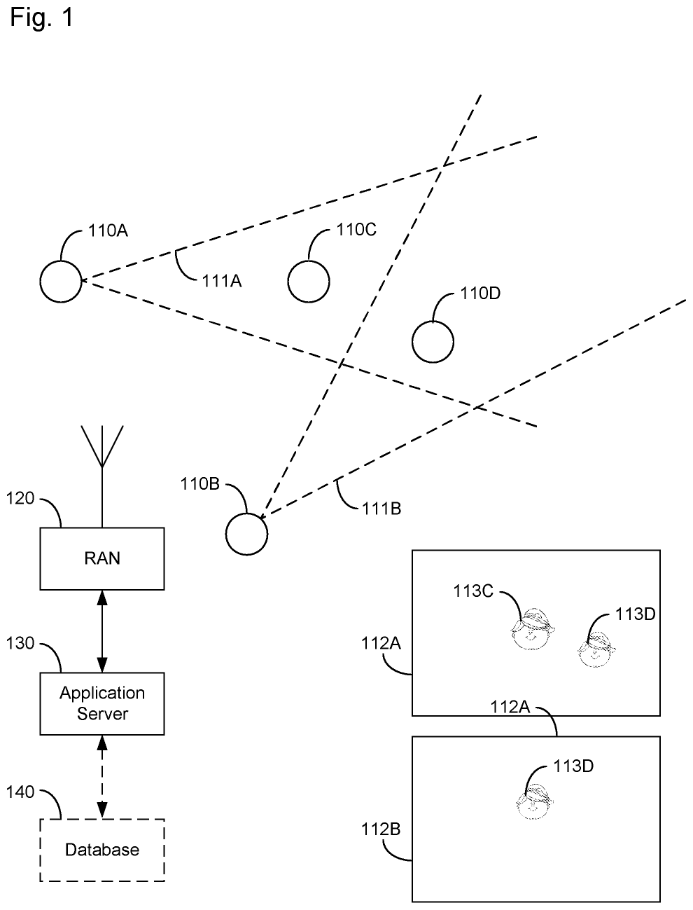

In FIG. 1, recognizing faces 113C and 113D (collectively referred to as 113) which are present in images 112A and 112B (collectively referred to as 112) captured by Mobile Communications Devices (MCDs) 110A and 1106, respectively, is illustrated. The faces 113C and 113D are faces of users carrying other mobile communications devices 110C and 110D, respectively. The process of recognizing faces which are present in images is known as face recognition, and is well known in the art. For instance, photo applications which are available for today's smartphones are capable of recognizing faces of persons which are known to the user of the smartphone.

In the present context, an image is understood to be data representing digital content as captured (i.e., recorded and stored) by a digital camera. In the present context, the term image or images may also include video comprising a series of images. The mobile communications devices 110A-110D (collectively referenced as 110) may in particular be embodied as user devices such as smartphones, mobile phones, tablets, smartwatches, digital cameras with wireless connectivity, camera glasses, Augmented/Virtual Reality (AR/VR) headsets, Head-Mounted Displays (HMDs), life loggers, or the like, which have the ability to capture, i.e., record and store, images for subsequent image processing using a face-recognition algorithm.

Face recognition on an image captured by a mobile communications device 110 of a user may either performed by the mobile communications device 110 after capturing the image, or by an application server 130 to which the captured image, or data representing faces of one or more persons which are present in the captured image, is transferred. The application server 130 may, e.g., be a server of a social-network provider, and may be implemented as a network node or as a virtual instance in a cloud environment. If face recognition has been successful, the name, or other suitable identifier, of a successfully recognized face (or rather the name of the person whose faces has been successfully recognized) may be associatively stored with the image e.g., as metadata, or in a database. The name may be any one, or a combination of, a real name, a username, a nickname, an alias, an email address, a user ID, a name tag, and a hashtag.

Known solutions for recognizing faces of persons which are present in an image captured by a mobile communications device are typically limited to persons known to the user who has captured the image. Contact information for such persons are typically stored in, or accessible by, the mobile communications device of a user, and may include the user's social-network contacts. This is the case since face recognition algorithms classify faces which are present in images based on facial features which are extracted from images of faces of known, i.e., identified, persons. These may, e.g., be faces which are present in images which the user has stored in his/her mobile communications device, or in a cloud storage or application server accessible by the user's mobile communications device, and which are associated with contact information. For instance, such images may be associatively stored with contact information as a profile picture, or by tagging the images with the names of one or more persons which are visible in the images. The tagging images capturing several faces may be accomplished by storing metadata identifying a position of a face within the image, e.g., using a set of coordinates defining a center of, or a bounding box encompassing, the face, as well as information identifying the person, such as a name or other suitable identifier. As an alternative, information identifying a position of a face within an image and information identifying the person may be associatively stored in a database comprised in, or accessible by, the mobile communications device.

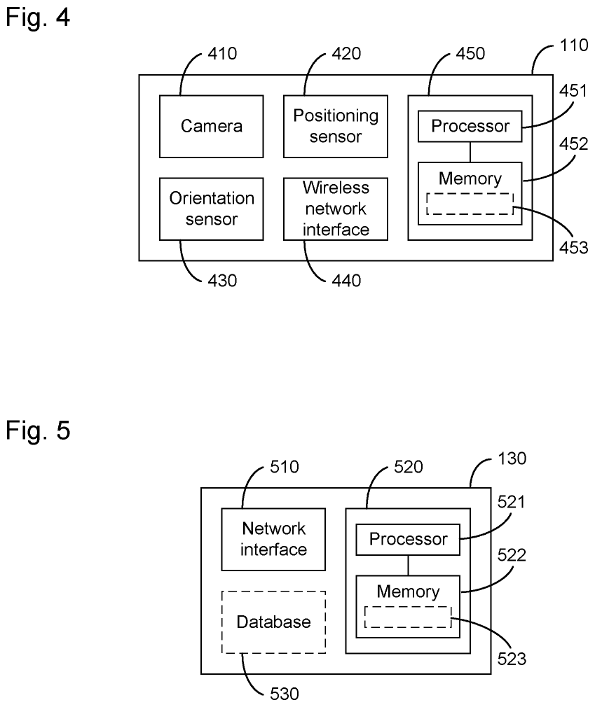

In the scenario depicted in FIG. 1, two users visiting a location capture images 112A and 112B of a scene with their mobile communications devices 110A and 110B, respectively, which may, e.g., be smartphones. The mobile communications devices 110A and 110B have fields-of-view 111A and 111B, respectively, (in FIG. 1 illustrated as acute angles limited by dashed lines 111A/B, and collectively referenced as 111), which are determined by properties of the cameras 410 (see FIG. 4) comprised in the mobile communications devices 110A and 110B.

The field-of-view of a camera may be adjustable by modifying the optics of the camera, e.g., by changing its focal length (aka optical zoom) or by cropping the area of the image which is captured by the camera (aka digital zoom). That is, the field-of-view is a characteristic of each captured image and may be determined based on the current configuration of the camera (e.g., if optical zoom is used) or settings of a camera app executed on a smartphone (e.g., if digital zoom is used). In general, the field-of-view may be expressed in terms of the angular size of the view cone, as an angle-of-view. For a conventional camera lens, the diagonal field of view FoV can be calculated as

$$FoV = {tan}^{- 1} ( \frac{S ensorSi z e}{2 f} ) ,$$

where SensorSize is the size of the camera sensor and f its focal length.

Also illustrated in FIG. 1 are two other users carrying mobile communications devices 110C and 110D, which are depicted as being positioned within the field-of-view 111A of the mobile communications device 110A. In addition, the user of mobile communications devices 110D is depicted as being positioned within the field-of-view 111B of the mobile communications devices 110B. Accordingly, the user of the mobile communications device 110C is likely to be present, i.e., visible, in an image 112A which is captured by the mobile communications device 110A, and the user of the mobile communications device 110D is likely to be present in images 112A and 112B which are captured by the mobile communications devices 110A and 110B, respectively. Accordingly, depending on the directions of gaze of the users of the mobile communications devices 110C and 110D, their faces 113C and 113D may be visible in the images 112A and 112B captured by the mobile communications devices 110A and 110B. This is exemplified in FIG. 1, which schematically illustrates an image 112A captured by the mobile communications device 110A, presenting faces 113C and 113D of the users of mobile communications devices 110C and 110D, respectively. Correspondingly, an image 112B captured by the mobile communications device 110B may present the face 113D of the user of the mobile communications device 110D (albeit at a different angle as compared to image 112A).

The solution provided herein is directed to assisting recognition of faces 113 (aka face recognition) which are present in images 112 captured by mobile communications device (such as mobile communications device 110A/B), which faces 113 are faces of users carrying other mobile communications devices (such as mobile communications device 110C/D). This may be the case if users carry their mobile communications devices 110A and 110B during a trip, e.g., for capturing images 112 of a sight they are visiting. As may be the case, other persons, carrying their mobile communications devices 110C and 110D, may accidently be positioned within the fields-of-view 111 of the cameras during capturing the images 112, and these persons, in particular their faces 113, may accordingly be potentially present in the captured images 112.

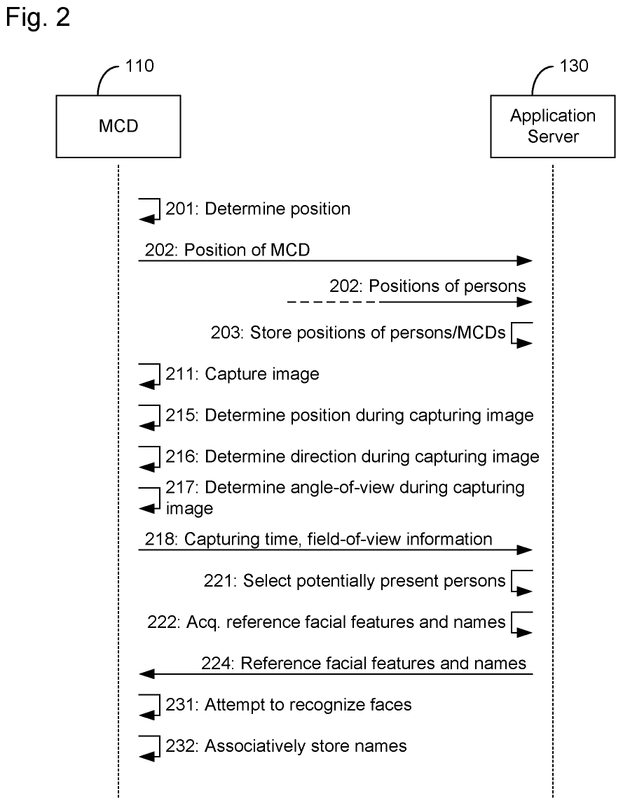

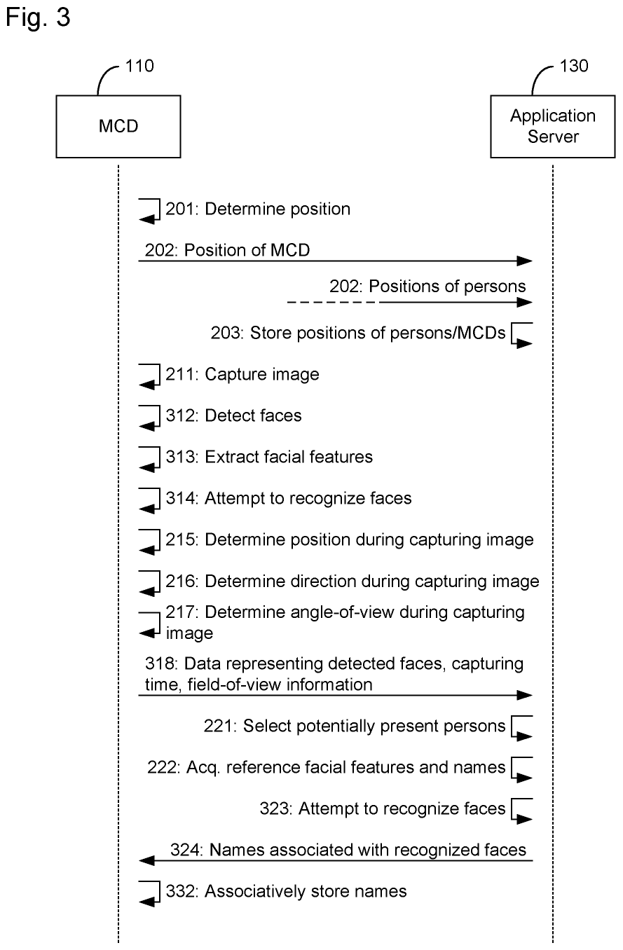

In the following, embodiments of the mobile communications device 110 and the application server 130 are described with reference to FIGS. 2 and 3, which show sequence diagrams illustrating recognition of faces 113 which are present in an image 112 captured by a mobile communications device 110, where face recognition is performed the mobile communications device 110 (FIG. 2), or by the application server 130 (FIG. 3), respectively.

Embodiments of the mobile communications device 110, which are schematically illustrated in FIG. 4, comprise a camera 410, a positioning sensor 420, an orientation sensor 430, a wireless network interface 440, and a processing circuit 450.

The camera 410 is a digital camera, e.g., of CMOS type which is prevalent in today's smartphones, and is configured to capture images with a field-of-view 111 which is determined by the current position and orientation of the camera 410 (and, accordingly, that of the mobile communications device 110 to which the camera 410 is fixated) in space.

The positioning sensor 420 is configured to determine a current position of the mobile communications device 110, and accordingly the camera 410. It may either be based on the Global Positioning System (GPS), the Global Navigation Satellite System (GNSS), China's BeiDou Navigation Satellite System (BDS), GLONASS, or Galileo, or may receive position information via the wireless network interface 440, e.g., from a positioning server. The position information may, e.g., be based on radio triangulation, radio fingerprinting, or crowd-sourced identifiers which are associated with known positions of access points of wireless communications networks (e.g., cell-IDs or WLAN SSIDs). The current position of the mobile communications device 110 may, e.g., be made available via an Application Programming Interface (API) provided by an operating system of the mobile communications device 110. The current position at the time of capturing an image may be stored as metadata with the image, or in a separate data record, e.g., in a database comprised in, or accessible by, the mobile communications device 110.

The orientation sensor 430 is configured to determine a current orientation of the mobile communications device 110, and accordingly the camera 410, relative to a reference frame, e.g., the direction of gravity. It may comprise one or more sensors of different type, such as accelerometers, gyroscopes, and magnetometers, which are common in today's smartphones. The current orientation of the mobile communications device 110 may, e.g., be made available via an API provided by the operating system of the mobile communications device 110. The current orientation at the time of capturing an image may be stored as metadata with the image, or in a separate data record, e.g., in a database comprised in, or accessible by, the mobile communications device 110.

The wireless network interface 440 is configured to access the wireless communications network 120 and thereby enable the mobile communications device 110 to communicate, i.e., exchange data in either direction (uplink or downlink), with the application server 130 and optionally any other network node which is accessible via the wireless communications network 120, e.g., a positioning server. It may, e.g., comprise one or more of a cellular modem (e.g., GSM, UMTS, LTE, 5G, NR/NX), a WLAN/Wi-Fi modem, a Bluetooth modem, a Visible Light Communication (VLC) modem, and the like.

The processing circuit 450 may comprise one or more processors 451, such as Central Processing Units (CPUs), microprocessors, application-specific processors, Graphics Processing Units (GPUs), and Digital Signal Processors (DSPs) including image processors, or a combination thereof, and a memory 452 comprising a computer program 453 comprising instructions. The computer program 453 is configured, when executed by the processor(s) 451, to cause the mobile communications device 110 to perform in accordance with embodiments of the invention described herein. The computer program 453 may be downloaded to the memory 452 by means of the wireless network interface 440, as a data carrier signal carrying the computer program 453. The processor(s) 451 may further comprise one or more Application-Specific Integrated Circuits (ASICs), Field-Programmable Gate Arrays (FPGAs), or the like, which in cooperation with, or as an alternative to, the computer program 453 are configured to cause the mobile communications device 110 to perform in accordance with embodiments of the invention described herein.

The mobile communications device 110 may further comprise a database (not shown in FIG. 4), either as part of the memory 452, or as a separate data storage, such as a removable memory card which is frequently used in today's smartphones for storing images. The database may be used for storing images captured by the mobile communications device 110, as well as other data, such as contact information, profile images of contacts, reference facial features of contacts, names of successfully recognized faces, and so forth.

Embodiments of the application server 130, which are schematically illustrated in FIG. 5, comprise a network interface 510 and a processing circuit 520.

The network interface 510 is configured to enable the application server 130 to communicate, i.e., exchange data in either direction, with mobile communications devices 110, via the wireless communications network 120, and optionally with other network nodes, e.g., an external database 140 for storing names or other suitable identifiers of persons, images representing faces of such persons, facial features extracted from such images, or the like. It may be any type of wired or wireless network interface, e.g., Ethernet, WLAN/Wi-Fi, or the like.

The processing circuit 520 may comprise one or more processors 521, such as CPUs, microprocessors, application-specific processors, GPUs, and DSPs including image processors, or a combination thereof, and a memory 522 comprising a computer program 523 comprising instructions. The computer program 523 is configured, when executed by the processor(s) 521, to cause the application server 130 to perform in accordance with embodiments of the invention described herein. The computer program 523 may be downloaded to the memory 522 by means of the network interface 510, as a data carrier signal carrying the computer program 523. The processor(s) 521 may further comprise one or more ASICs, FPGAs, or the like, which in cooperation with, or as an alternative to, the computer program instructions 523 are configured to cause the application server 130 to perform in accordance with embodiments of the invention described herein.

With reference to FIGS. 2 and 3, the embodiments described herein assist recognition of faces 113 which are present in an image 112 captured by a mobile communications device 110A/B by transmitting 218/318 information indicating a time of capturing the image, and information pertaining to a field-of-view 111 of the camera 410 during capturing the image, to an application server 130, and receiving 224/324 identification information pertaining to one or more persons which are potentially present in the captured image from the application server 130. The one or more persons which are potentially present in the captured image are selected 221 by the application server 130 as persons which were positioned within the field-of-view 111 of the camera during capturing the image. More specifically, they may be selected 221 based on the information indicating a time of capturing the image, the information pertaining to a field-of-view 111 of the camera during capturing the image, and positions of the one or more persons during capturing the image. The positions of the one or more persons may be time-stamped position information which the application server 130 receives 202 from the mobile communications devices 110C and 110D.

The selection 221 of one or more persons which are potentially present in an image 120 captured by the mobile communications device 110A or 1108 as persons which were positioned within the field-of-view 111 of the camera during capturing the image is based on the understanding that these persons have been carrying their mobile communications devices 110C and 110D when the image was captured. In other words, the positions of the mobile communications devices 110C and 110D are assumed to be the positions of their respective users.

In the present context, “one or more persons which are potentially present in the captured image”, and which are selected by the application server 130 as persons which were positioned within the field-of-view 111 of the camera during capturing the image, is to be understood as covering scenarios in which the face of the user whose mobile communications device 110C or 110D was positioned within the field-of-view 111 of the camera during capturing the image is not present in the captured image. This may, e.g., be the case if the user's face was turned away from the camera during capturing the image, the user or his/her face was obscured by another person or persons or an object during capturing the image, or the face of the user was actually outside the field-of-view 111 of the camera, maybe because the mobile communications device 110C or 110D was located in a pocket of the user's trousers during capturing the image.

Advantageously, the solution presented herein does not require any prior relation between users capturing images and other users whose faces are present in the captured images. Since positioning sensors and orientation sensors are prevalent in modern mobile communications devices such as smartphones, the described solution provides an efficient means of improving face recognition in images captured by mobile communications devices.

Whereas embodiments of the application server 130 are herein described as utilizing position information which is received from the mobile communications devices 110C and 110D, it will be appreciated that the application server 130 may alternatively receive position information from electronic devices which are carried by users and which can determine and report their position over time other than the mobile communications devices 110. For instance, this may be positioning devices such as GPS trackers, fitness wearables, or the like.

More specifically, and with reference to FIGS. 2 and 3, the mobile communications device 110A/B is operative to capture 211 an image using the camera. Capturing an image may be triggered by a user of the mobile communications device 110, e.g., by pressing a camera button which may either be a hardware button provided on a face of the mobile communications device 110, or a virtual button which is displayed on a touchscreen comprised in the mobile communications device 110 as part of the user interface of a camera app, as is known in the art. Alternatively, capturing the image may be effected repeatedly, periodically, or regularly, or if a current position of the mobile communications device 110 has changed by more than a threshold value (which may optionally be configured by the user of the mobile communications device 110), in an always-on camera, or life-logger, type of fashion.

The mobile communications device 110 is further operative to transmit 218/318 information indicating a time of capturing the image, and information pertaining to a field-of-view 111 of the camera 410 during capturing the image, to the application server 130. The information indicating the time of capturing the image, and the information pertaining to the field-of-view of the camera during capturing the image, may be transmitted together in a single message exchange, or in separate message exchanges between the mobile communications device 110 and the application server 130. The information indicating the time of capturing the image may, e.g., comprise a time stamp which is obtained from a clock comprised in the mobile communications device 110. The current time may, e.g., be obtained via an API provided by the operating system of the mobile communications device 110. The time of capturing an image may be stored as metadata with the captured image, or in a separate data record.

The mobile communications device 110 is further operative to receive 224/324 identification information pertaining to one or more persons which are potentially present in the captured image from the application server 130. As is described hereinbefore, the one or more persons which are potentially present in the captured image are persons are selected 221, by the application server 130, as persons which were positioned within the field-of-view 111 of the camera during capturing the image.

The mobile communications device 110 may be operative to determine the field-of-view 111 of the camera 410 during capturing the image based on information received from the positioning sensor 420 and the orientation sensor 430. More specifically, mobile communications device 110 may be operative to determine 215 a position of the mobile communications device 110 during capturing the image using the positioning sensor 420, and to determine 216 a direction in which the camera 410 is pointing during capturing the image using the orientation sensor 430. The information may either be received directly from the positioning sensor 420 and the orientation sensor 430, respectively, or via an API of the operating system of the mobile communications device 110.

Optionally, the mobile communications device 110 may be operative to determine the field-of-view 111 of the camera 410 during capturing the image further based on information received from the camera 410. More specifically, the mobile communications device 110 may be operative to determine 217 an angle-of-view of the camera 410 during capturing the image based on information pertaining to a configuration of the camera 410. The information may either be received directly from the camera 410, via an API of the operating system, as is described hereinbefore, or via an API of a camera app which is executed on the mobile communications device 110 and which is provided for controlling the camera 410 via a (optionally touch-based) user-interface of the mobile communications device 110. The information may, e.g., relate to one or more of a current focal-length setting of the camera 410, a size of the sensor of the camera 410, a current angle-of-view of the camera 410, or the like.

The transmitted 218/318 information pertaining to the field-of-view 111 of the camera during capturing the image comprises the determined 215 position and the determined 216 direction. It may optionally further comprise the determined 217 angle-of-view.

For the purpose of assisting other mobile communications devices to perform face recognition in accordance with embodiments of the invention, the mobile communications device 110 may further be operative to determine 201 a position of the mobile communications device 110 using the positioning sensor 420, and to transmit 202 information pertaining to the determined position of the mobile communications device 110 to the application server 130. The position of the mobile communications device 110 may be reported regularly, periodically, on request by the application server 130, or if a position of the mobile communications device 110 has changed by more than a threshold distance. Position information may either be transmitted 202 one at a time, optionally together with information indicating a time of determining 201 the transmitted position, or as a sequence of position-time pairs.

Further with reference to FIGS. 2 and 3, the application server 130 is operative to receive 202 information pertaining to positions of persons at respective times, and to store 203 the received information pertaining to positions of persons at respective times in a database. In particular, the application server 130 may be operative to receive 202 the information pertaining to positions of persons at respective times as positioning information from other mobile communications devices 110C/D carried by the persons. The database may either be comprised in, or co-located with, the application server 130 (such as database 530 shown in FIG. 5), or provided separately from the application server 130 and accessible by the application server 130 via network interface 510 (such as database 140 shown in FIG. 1), e.g., as a cloud-based storage. Additionally or alternatively, the application server 130 may be operative to receive 202 the information pertaining to positions of persons at respective times as positioning information from positioning devices such as GPS trackers, fitness wearables, or the like.

The application server 130 is further operative to receive 218/318 information indicating a time of capturing an image by a camera comprised in a mobile communications device 110, and information pertaining to a field-of-view 111 of the camera during capturing the image, from the mobile communications device 110. The information indicating the time of capturing the image, and the information pertaining to the field-of-view 111 of the camera during capturing the image, may be received 218/318 together in a single message exchange, or in separate message exchanges between the mobile communications device 110 and the application server 130.

The application server 130 is further operative to select 221 one or more persons which are potentially present in the captured image 112, in particular as persons which were positioned within the field-of-view 111 of the camera during capturing the image. More specifically, the application server 130 may be operative to select 221 the one or more persons which are potentially present in the captured image based on the received 218/318 information indicating a time of capturing the image, the received 218/318 information pertaining to a field-of-view 111 of the camera during capturing the image, and the positions of persons at respective times stored 203 in the database 140/530. That is, if the position of a person was within the field-of-view 111 of the camera when an image was captured, that person is selected 221 as a person which is potentially present in the captured image.

As was described hereinbefore, the selected 221 one or more persons which are potentially present in the captured image, or their faces, may not necessarily be present in the captured image, e.g., owing to the fact the user's face was turned away from the camera during capturing the image, the user or his/her face was obscured by another person or persons or an object during capturing the image, or the face of the user was actually outside the field-of-view 111 of the camera, maybe because the mobile communications device 110C or 110D was located in a pocket of the user's trousers during capturing the image. It may also be the case that the face of a person is not recognizable because of inferior image quality.

The application server 130 may be operative to further receive 202 information pertaining to directions of gaze of the persons at respective times, to store 203 the received information pertaining to directions of gaze of the persons at respective times in the database 140/530, and to select 221 the one or more persons which are potentially present in the captured image further based on their directions of gaze during capturing the image. For instance, preference may be given to persons which are gazing towards the mobile communications device 110 during capturing the image, as it is more likely that their faces can be recognized successfully. The direction of gaze of a person may, e.g., be derived from a movement of the person, assuming that the person is looking forward while walking. Alternatively, the direction of gaze may be derived from Google Glasses or an HMD worn by the person, or from a mobile phone which the person is holding while capturing an image or making a voice call, as the direction of gaze can be derived from the orientation of the mobile phone (held in front of the user's face or close to the user's ear, respectively).

Optionally, the application server 130 may be operative to select 221 the one or more persons which are potentially present in the captured image further based on distances between positions of persons and the mobile communications device 110 during capturing the image. For instance, this may be achieved by using a threshold distance, or by prioritizing the selected persons based on distance. Preference may be given to persons which were positioned at shorter distance from the mobile communications device 110 during capturing the image, as it is more likely that their faces can be recognized successfully.

The application server 130 is further operative to acquire 222 identification information pertaining to the one or more selected 221 persons which are potentially present in the captured image. More specifically, the acquired 222 identification information pertaining to one or more persons which are potentially present in the captured image comprises reference facial features of the one or more persons, and names which are associated with the one or more persons. The reference facial features and names may, e.g., be retrieved from a database 140/530, which may be a hosted by a social-network server. Alternatively, the application server 130 may be operative to retrieve an image presenting a person's face from the database 140/530, such as a social-network profile image, and extract the reference facial features from the retrieved image.

The acquired 222 identification information may not necessarily comprise reference facial features of all selected 221 persons which are potentially present in the captured image, e.g., because facial features of users of other mobile communications devices 110 may not be available, or only be made available if their users have opted-in, i.e., agreed to making their facial features available for the purpose of face recognition, or have not opted-out from making their facial features available. This may, e.g., be achieved by a privacy setting allowing or preventing sharing of reference facial features, or an image from which reference facial features can be extracted.

The application server 130 is further operative to transmit 224/324 at least part of the acquired 222 identification information pertaining to one or more persons which are potentially present in the captured image to the mobile communications device 110.

In the following, and with reference to FIG. 2, certain embodiments of the invention are described which rely on face recognition performed by the mobile communications device 110, using the identification information received 224 from the application server 130.

The application server 130 is operative to transmit 224 as identification information pertaining to one or more persons which are potentially present in the captured image reference facial features of the one or more persons, and names which are associated with the one or more persons, to the mobile communications device 110. The mobile communications device 110 is further operative to attempt 231 to recognize faces of the one or more persons by performing face recognition on the captured image using the received 224 reference facial features, and to associatively store 232 names of successfully recognized faces, or rather names which are associated with persons whose faces have been recognized successfully. For instance, the names, or other suitable identifiers, of persons whose faces have been successfully recognized 231 may be stored 232 as metadata together with the captured image, or in a database comprised in, or accessible by, the mobile communications device 110.

In the following, and with reference to FIG. 3, alternative embodiments of the invention are described which rely on face recognition performed by the application server 130.

The mobile communications device 110 is further operative to detect 312 faces of one or more persons which are present in the captured image, and to transmit 318 data representing the detected faces of one or more persons which are present in the captured image to the application server 130. The data representing the detected faces may either be transmitted 318 together with the information indicating a time of capturing the image, and the information pertaining to a field-of-view 111 of the camera during capturing the image, or in a separate message exchange. In this case, the identification information which is received 324 from the application server comprises names which are associated with the one or more persons. These are names of persons whose faces have been successfully recognized by the application server 130.

The transmitted 318 data representing the detected faces of the one or more persons which are present in the captured image may comprise image data representing the detected faces. This may, e.g., be the captured image or an image derived therefrom, e.g., cropped regions encompassing the detected faces. Optionally, the captured image, or cropped regions encompassing one or more faces, may either be transmitted 318 in the same format as they were captured by the camera 410, i.e., in raw data format or in a compressed file format, or as a compressed version of the captured image with reduced resolution and/or color space, thereby reducing bandwidth which is required for transmitting 318 the image data to the application server 130 via the wireless communications network 120 and any other interconnected communications network.

Alternatively, the mobile communications device 110 may be operative to extract 313 facial features of the detected faces, and to transmit 318 the extracted facial features as the transmitted data representing the detected faces of the one or more persons which are present in the captured image.

Optionally, the mobile communications device 110 may be operative to attempt 314 to recognize the detected faces using reference facial features which are accessible by the mobile communications device 110, wherein the transmitted 318 data representing the detected faces of the one or more persons which are present in the captured image only represents faces which have not been recognized successfully. The reference facial features which are accessible by the mobile communications device 110 may, in particular, comprise reference facial features of persons which are known to a user of the mobile communications device 110. For instance, this may be reference facial features which can be extracted from images stored in, or accessible by, the mobile communications device 110 which present faces of persons which are known to the user of the mobile communications device. The reference facial features may, e.g., be stored in a database comprised in, or accessible by, the mobile communications devices, or as metadata together which profile images of the persons. Alternatively, such reference facial features may also be made available by a social-network provider.

Further with reference to FIG. 3, the application server 130 is operative to receive 318 data representing detected faces of one or more persons which are present in the captured image from the mobile communications device 110. In correspondence to what is described above, the data representing the detected faces may either be received 318 together with the information indicating a time of capturing the image, and the information pertaining to a field-of-view 111 of the camera during capturing the image, or in a separate message exchange.

The received 318 data representing the detected faces of the one or more persons which are present in the captured image may comprise image data representing the detected faces. This may, e.g., be the captured image or an image derived therefrom, e.g., cropped regions encompassing the detected faces. Optionally, the captured image, or cropped regions encompassing one or more faces, may either be received 318 in the same format as they were captured by the camera 410 of the mobile communications device 110, i.e., in raw data format or in a compressed file format, or as a compressed version of the captured image with reduced resolution and/or color space, thereby reducing bandwidth which is required for receiving 318 the image data from the mobile communications device 110 via the wireless communications network 120 and any other interconnected communications network.

Alternatively, the received 318 data representing detected faces of the one or more persons which are present in the captured image may comprise extracted facial features of the detected faces.

The application server 130 is further operative to attempt 323 to recognize the detected faces of the one or more persons by performing face recognition on the received 318 data representing detected faces of the one or more persons which are present in the captured image using the acquired 222 reference facial features. The identification information which is transmitted 324 to the mobile communications device comprises names which are associated with the one or more persons whose faces have been successfully recognized.

It will be appreciated that the information pertaining to positions of persons at respective times which is received 202 by the application server 130, and which is used for selecting 221 select one or more persons which are potentially present in images captured by the mobile communications device 110 based on a field-of-view during 111 capturing the images, may not exactly coincide with the times of capturing the images. In this case, the received 202 information pertaining to positions of persons at respective times (position information) may be interpolated to estimate approximate positions of the persons respective times of capturing the images. Alternatively, persons may be selected 221 based on position information which is received 202 for times which are close in time to times of capturing the images, and optionally further based on a speed of the persons at the relevant times. For instance, if a person was substantially stationary during a certain duration of time, the selection 221 does not require exact matching of position timestamps with capturing times.

The exchange of data and information between the mobile communications devices 110 and the application server 130, in particular transmitting 218/318 information indicating a time of capturing the image, and information pertaining to a field-of-view of the camera during capturing the image, from a mobile communications device 110 to the application server 130, and receiving 224/324 identification information pertaining to one or more persons which are potentially present in the captured image by the mobile communications device 110 from the application server 130, is effected via a wireless communications network 120, e.g., a Radio Access Network (RAN), such as a cellular telecommunications network (e.g., GSM, UMTS, LTE, 5G, NR/NX) a Wireless Local Area Network (WLAN)/Wi-Fi network, Bluetooth, or any other kind of radio- or light-based communications technology. In addition to the wireless communications network 120, the exchange of data and information between the mobile communications devices 110 and the application server 130 may involve additional communications networks such as the Internet (not shown in FIG. 1).

The mobile communications device 110 is operative to exchange information with the application server 130 using any suitable network protocol, combination of network protocols, or protocol stack. For instance, the mobile communications device 110 may be operative to utilize the HyperText Transfer protocol (HTTP), the Transmission Control Protocol (TCP), the Internet Protocol (IP), the User Datagram Protocol (UDP), the Constrained Application Protocol (CoAP), or the like. The application server 130 is operative to exchange information with the mobile communications devices 110, and optionally with an external database 140, using one or more corresponding network protocols.

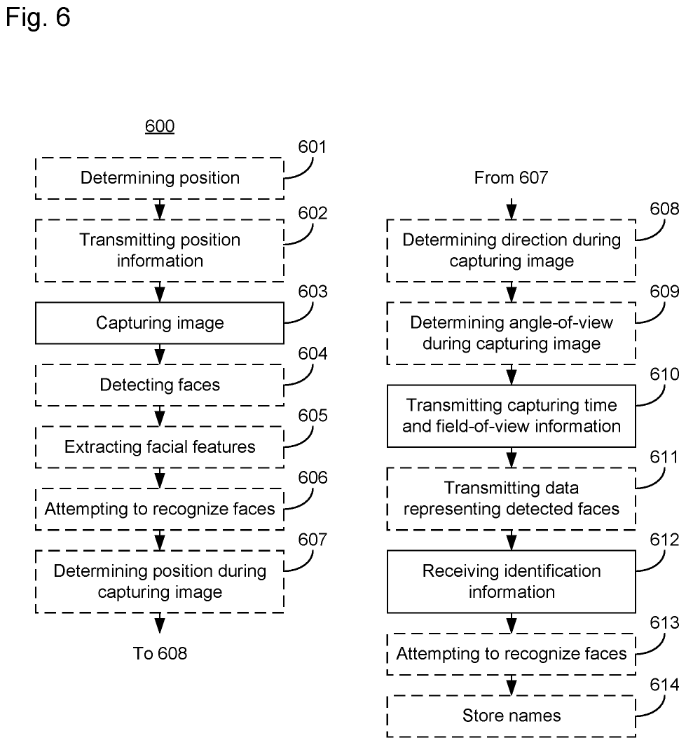

In the following, embodiments of a method 600 performed by a mobile communications device, such as the mobile communications device 110, are described with reference to FIG. 6.

The method 600 comprises capturing 603 an image using a camera comprised in the mobile communications device, and transmitting 610 information indicating a time of capturing the image, and information pertaining to a field-of-view 111 of the camera during capturing the image, to an application server. The method 600 further comprises receiving 612 identification information pertaining to one or more persons which are potentially present in the captured image from the application server. The one or more persons which are potentially present in the captured image may be persons which were positioned within the field-of-view 111 of the camera during capturing the image. In particular, the one or more persons which are potentially present in the captured image may be selected based on the information indicating a time of capturing the image, the information pertaining to a field-of-view 111 of the camera during capturing the image, and positions of the one or more persons during capturing the image.

Optionally, the received identification information pertaining to one or more persons which are potentially present in the captured image comprises reference facial features of the one or more persons, and names which are associated with the one or more persons. The method 600 further comprising attempting 613 to recognize faces of the one or more persons by performing face recognition on the captured image using the received reference facial features, and associatively storing 614 names of successfully recognized faces.

Optionally, the method 600 further comprises detecting 604 faces of one or more persons which are present in the captured image, and transmitting 611 data representing the detected faces of one or more persons which are present in the captured image to the application server. The received identification information comprises names which are associated with the one or more persons. The transmitted data representing the detected faces of the one or more persons which are present in the captured image may comprise image data representing the detected faces. Alternatively, the method 600 may further comprise extracting 605 facial features of the detected faces, wherein the transmitted data representing the detected faces of the one or more persons which are present in the captured image comprises the extracted facial features.

Optionally, the method 600 further comprises attempting 606 to recognize the detected faces using reference facial features which are accessible by the mobile communications device, wherein the transmitted data representing the detected faces of the one or more persons which are present in the captured image only represents faces which have not been recognized successfully. The reference facial features which are accessible by the mobile communications device may comprise reference facial features of persons known to a user of the mobile communications device.

Optionally, the field-of-view 111 of the camera during capturing the image is determined based on information received from a positioning sensor and an orientation sensor comprised in the mobile communications device. The field-of-view 111 of the camera during capturing the image may be determined further based on information received from the camera.

Optionally, the method 600 further comprises determining 607 a position of the mobile communications device during capturing the image using a positioning sensor comprised in the mobile communications device, and determining 608 a direction in which the camera is pointing during capturing the image using an orientation sensor comprised in the mobile communications device. The information pertaining to the field-of-view 111 of the camera during capturing the image comprises the determined position and the determined direction. The method 600 may further comprise determining 609 an angle-of-view of the camera during capturing the image based on information pertaining to a configuration of the camera, wherein the information pertaining to the field-of-view 111 of the camera during capturing the image further comprises the determined angle-of-view.

Optionally, the method 600 further comprises determining 601 a position of the mobile communications device using a positioning sensor comprised in the mobile communications device, and transmitting 602 information pertaining to the determined position of the mobile communications device to the application server.

It will be appreciated that the method 600 may comprise additional, alternative, or modified, steps in accordance with what is described throughout this disclosure. An embodiment of the method 600 may be implemented as a computer program 453 comprising instructions which, when the computer program is executed by a processor 451 comprised in a mobile communications device 110, cause the mobile communications device 110 to carry out an embodiment of the method 600. The computer program 453 may be stored on a computer-readable storage medium 452, such as a memory stick, a Random-Access Memory (RAM), a Read-Only Memory (ROM), a Flash memory, a CDROM, a DVD, or the like. Alternatively, the computer program 453 may be carried by a data carrier signal, e.g., when the computer program is downloaded to a mobile communications device 110 via a wireless network interface 440 comprised in the mobile communications device 110.

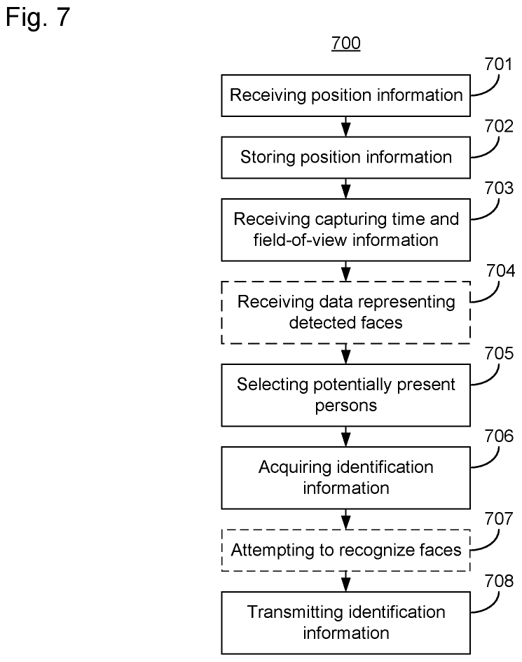

In the following, embodiments of a method 700 performed by an application server, such as the application server 130, are described with reference to FIG. 7.

The method 700 comprises receiving 701 information pertaining to positions of persons at respective times, and storing 702 the received information pertaining to positions of persons at respective times in a database. The method 700 further comprises receiving 703 information indicating a time of capturing an image by a camera comprised in a mobile communications device, and information pertaining to a field-of-view 111 of the camera during capturing the image, from the mobile communications device, and selecting 705 one or more persons which are potentially present in the captured image. The method 700 further comprises acquiring 706 identification information pertaining to the one or more selected persons which are potentially present in the captured image, and transmitting 708 at least part of the acquired identification information pertaining to one or more persons which are potentially present in the captured image to the mobile communications device. The one or more persons which are potentially present in the captured image may be selected 705 as persons which were positioned within the field-of-view 111 of the camera during capturing the image. In particular, the one or more persons which are potentially present in the captured image may be selected 705 based on the received information indicating a time of capturing the image, the received information pertaining to a field-of-view 111 of the camera during capturing the image, and the positions of persons at respective times stored in the database.

Optionally, the method 700 may further comprise receiving information pertaining to directions of gaze of the persons at respective times and storing the received information pertaining to directions of gaze of the persons at respective times in the database, wherein the selecting 705 the one or more persons which are potentially present in the captured image is further based on their directions of gaze during capturing the image.

Optionally, the acquired identification information pertaining to one or more persons which are potentially present in the captured image may comprise reference facial features of the one or more persons, and names which are associated with the one or more persons, and the acquired identification information is transmitted 708 to the mobile communications device.

Optionally, the acquired identification information pertaining to one or more selected persons which are potentially present in the captured image may comprise reference facial features of the one or more persons, and names which are associated with the one or more persons, and the method 700 further comprises receiving data 704 representing detected faces of one or more persons which are present in the captured image from the mobile communications device, and attempting 707 to recognize the detected faces of the one or more persons by performing face recognition on the received data representing the detected faces of the one or more persons which are present in the captured image using the acquired reference facial features. The transmitted 708 identification information comprises names which are associated with the one or more persons whose faces have been successfully recognized. The received data representing detected faces of the one or more persons which are present in the captured image may comprise image data representing the detected faces. Alternatively, the received data representing detected faces of the one or more persons which are present in the captured image may comprise extracted facial features of the detected faces.

Optionally, the information pertaining to positions of persons at respective times may be received 701 as positioning information from other mobile communications devices carried by the persons.

Optionally, the identification information pertaining to the one or more selected persons which are potentially present in the captured image may be acquired from a social-network server.

It will be appreciated that the method 700 may comprise additional, alternative, or modified, steps in accordance with what is described throughout this disclosure. An embodiment of the method 700 may be implemented as a computer program 523 comprising instructions which, when the computer program is executed by a processor 521 comprised in an application server 130, cause the application server 130 to carry out an embodiment of the method 700. The computer program 523 may be stored on a computer-readable storage medium 522, such as a memory stick, a Random-Access Memory (RAM), a Read-Only Memory (ROM), a Flash memory, a CDROM, a DVD, or the like. Alternatively, the computer program 523 may be carried by a data carrier signal, e.g., when the computer program is downloaded to an application server 130 via a network interface 510 comprised in the application server 130.

The person skilled in the art realizes that the invention by no means is limited to the embodiments described above. On the contrary, many modifications and variations are possible within the scope of the appended claims.

1. A mobile communications device comprising:
a camera,
a positioning sensor,
an orientation sensor,
a wireless network interface, and
a processing circuit causing the mobile communications device to be operative to:
capture an image using the camera,
transmit information indicating a time of capturing the image, and information pertaining to a field-of-view of the camera during capturing the image, to an application server, and
receive identification information pertaining to one or more persons which are potentially present in the captured image from the application server.

2. The mobile communications device according to claim 1, wherein the one or more persons which are potentially present in the captured image are persons which were positioned within the field-of-view of the camera during capturing the image.

3. The mobile communications device according to claim 1, wherein the one or more persons which are potentially present in the captured image are selected based on the information indicating a time of capturing the image, the information pertaining to a field-of-view of the camera during capturing the image, and positions of the one or more persons during capturing the image.

4. The mobile communications device according to claim 1, wherein the received identification information pertaining to one or more persons which are potentially present in the captured image comprises reference facial features of the one or more persons, and names which are associated with the one or more persons, the mobile communications device being further operative to:
attempt to recognize faces of the one or more persons by performing face recognition on the captured image using the received reference facial features, and
associatively store names of successfully recognized faces.

5. The mobile communications device according to claim 1, further operative to:
detect faces of one or more persons which are present in the captured image, and
transmit data representing the detected faces of one or more persons which are present in the captured image to the application server, wherein the received identification information comprises names which are associated with the one or more persons.

6. The mobile communications device according to claim 5, wherein the transmitted data representing the detected faces of the one or more persons which are present in the captured image comprises image data representing the detected faces.

7. The mobile communications device according to claim 5, further operative to extract facial features of the detected faces, wherein the transmitted data representing the detected faces of the one or more persons which are present in the captured image comprises the extracted facial features.

8. The mobile communications device according to claim 5, further operative to attempt to recognize the detected faces using reference facial features which are accessible by the mobile communications device, wherein the transmitted data representing the detected faces of the one or more persons which are present in the captured image only represents faces which have not been recognized successfully.

9. The mobile communications device according to claim 8, wherein the reference facial features which are accessible by the mobile communications device comprise reference facial features of persons known to a user of the mobile communications device.

10. The mobile communications device according to claim 1, operative to determine the field-of-view of the camera during capturing the image based on information received from the positioning sensor and the orientation sensor.

11. The mobile communications device according to claim 10, operative to determine the field-of-view of the camera during capturing the image further based on information received from the camera.

12. The mobile communications device according to claim 1, further operative to:
determine a position of the mobile communications device during capturing the image using the positioning sensor, and
determine a direction in which the camera is pointing during capturing the image using the orientation sensor,
wherein the information pertaining to the field-of-view of the camera during capturing the image comprises the determined position and the determined direction.

13. The mobile communications device according to claim 12, further operative to:
determine an angle-of-view of the camera during capturing the image based on information pertaining to a configuration of the camera,
wherein the information pertaining to the field-of-view of the camera during capturing the image further comprises the determined angle-of-view.

14. The mobile communications device according to claim 1, further operative to:
determine a position of the mobile communications device using the positioning sensor, and
transmit information pertaining to the determined position of the mobile communications device to the application server.

15. The mobile communications device according to claim 1, being any one of: a mobile phone, a smartphone, a tablet, a smartwatch, a digital camera, camera glasses, an Augmented Reality/Virtual Reality, AR/VR, headset, a Head-Mounted Display, HMD, and a life logger.

16. An application server comprising:
a network interface, and
a processing circuit causing the application server to be operative to:
receive information pertaining to positions of persons at respective times,
store the received information pertaining to positions of persons at respective times in a database,
receive information indicating a time of capturing an image by a camera comprised in a mobile communications device, and information pertaining to a field-of-view of the camera during capturing the image, from the mobile communications device,
select one or more persons which are potentially present in the captured image,
acquire identification information pertaining to the one or more selected persons which are potentially present in the captured image, and
transmit at least part of the acquired identification information pertaining to one or more persons which are potentially present in the captured image to the mobile communications device.

17. The application server according to claim 16, operative to select the one or more persons which are potentially present in the captured image as persons which were positioned within the field-of-view of the camera during capturing the image.

18. The application server according to claim 16, operative to select the one or more persons which are potentially present in the captured image based on the received information indicating a time of capturing the image, the received information pertaining to a field-of-view of the camera during capturing the image, and the positions of persons at respective times stored in the database.

19. The application server according to claim 16, operative to further receive information pertaining to directions of gaze of the persons at the times and to store the received information pertaining to directions of gaze of the persons at the times in the database, and
select the one or more persons which are potentially present in the captured image further based on their directions of gaze during capturing the image.

20. The application server according to claim 16, wherein the acquired identification information pertaining to the one or more selected persons which are potentially present in the captured image comprises reference facial features of the one or more persons, and names which are associated with the one or more persons, and the acquired identification information is transmitted to the mobile communications device.

21. The application server according to claim 16, wherein the acquired identification information pertaining to the one or more selected persons which are potentially present in the captured image comprises reference facial features of the one or more persons, and names which are associated with the one or more persons, the application server being further operative to:
receive data representing detected faces of one or more persons which are present in the captured image from the mobile communications device, and
attempt to recognize the detected faces of the one or more persons by performing face recognition on the received data representing detected faces of the one or more persons which are present in the captured image using the acquired reference facial features,
wherein the transmitted identification information comprises names which are associated with the one or more persons whose faces have been successfully recognized.

22. The application server according to claim 21, wherein the received data representing detected faces of the one or more persons which are present in the captured image comprises image data representing the detected faces.

23. The application server according to claim 21, wherein the received data representing detected faces of the one or more persons which are present in the captured image comprises extracted facial features of the detected faces.

24. The application server according to claim 16, operative to receive the information pertaining to positions of persons at respective times as positioning information from other mobile communications devices carried by the persons.

25. The application server according to claim 15, operative to acquire identification information pertaining to the one or more selected persons which are potentially present in the captured image from a social-network server.

26. A method performed by a mobile communications device, the method comprising:
capturing an image using a camera comprised in the mobile communications device,
transmitting information indicating a time of capturing the image, and information pertaining to a field-of-view of the camera during capturing the image, to an application server, and
receiving identification information pertaining to one or more persons which are potentially present in the captured image from the application server.

27-39. (canceled)

40. A computer program product comprising a non-transitory computer readable medium storing instructions which, when executed by a processor comprised in a mobile communications device, cause the mobile communications device to perform operations according to claim 26.

41. A computer-readable storage medium having stored thereon the computer program product according to claim 40.

42. A data carrier signal carrying the computer program product according to claim 40.

43. A method performed by an application server, the method comprising:
receiving information pertaining to positions of persons at respective times,
storing the received information pertaining to positions of persons at respective times in a database,
receiving information indicating a time of capturing an image by a camera comprised in a mobile communications device, and information pertaining to a field-of-view of the camera during capturing the image, from the mobile communications device,
selecting one or more persons which are potentially present in the captured image,
acquiring identification information pertaining to the one or more selected persons which are potentially present in the captured image, and
transmitting at least part of the acquired identification information pertaining to one or more persons which are potentially present in the captured image to the mobile communications device.

44-52. (canceled)
